(19) United States
(12) Patent Application Publication
(10) Pub. No.: US 2021/0387525 A1
(43) Pub. Date: Dec. 16, 2021

(54) METHOD FOR IMPROVING THE ENERGY EFFICIENCY OF A MOTOR VEHICLE, MOTOR VEHICLE, AND COMPUTER-READABLE MEDIUM

(71) Applicant: Bayerische Motoren Werke Aktiengesellschaft, Munich (DE)

(72) Inventors: Andreas GRUENIG, Munich (DE); Jens Adrian ROETH, Munich (DE); Alexander REINBOLD, Munich (DE); Benjamin HILDEBRANDT, Munich (DE); Mark VAN GELIKUM, Munich (DE); Florian BISSBORT, Munich (DE)

(21) Appl. No.: 17/309,340

(22) PCT Filed: Jul. 25, 2019
(86) PCT No.: PCT/EP2019/070015

§ 371 Date: May 20, 2021

(30) Foreign Application Priority Data
Nov. 30, 2018 (DE) 10 2018 130 443.9

(51) Int. Cl. B60K 35/00; B60W 50/14; G08G 1/0968

(52) U.S. Cl. CPC B60K 35/00; B60W 50/14; G08G 1/0968; B60W 2050/146; B60W 30/18163; B60K 2370/169; B60W 2552/05; B60W 2555/60; B60K 2370/174

(57) ABSTRACT

The invention relates to a method for improving the energy efficiency of a motor vehicle (1) comprising the steps of: detecting a driving situation; determining an efficient load range (23) for a power train (2) of the motor vehicle (1) depending on the detected driving situation; detecting a current load of the power train (2); and indicating the determined efficient load range (23) and the detected current load in a combined display device (4), so that a driver may selectively move the power train (2) of the motor vehicle (1) into the efficient load range (23).

The invention further relates to a motor vehicle (1) and a computer-readable medium comprising executable program code configured to execute the above method.

The invention relates to a method for improving the energy efficiency of a motor vehicle. The invention further relates to a motor vehicle comprising a power train, an on-board computer and at least one display device, and a computer-readable medium comprising executable program code.

In principle, the aim is to make motor vehicles as energy-efficient as possible in order to optimize their operation in economic and ecological terms. In addition to improvements to the motor vehicle itself, in particular the development of fuel-saving engines and other drive components, the focus is also on the most energy-efficient operation possible of a given motor vehicle. One difficulty here is that it is not always obvious to a driver of a motor vehicle by which measures he may improve the energy efficiency of his motor vehicle.

It is an object of the present invention to provide a method for improving the energy efficiency of a motor vehicle. The method is intended to enable a driver to operate his motor vehicle in the most energy-efficient manner possible. Furthermore, devices are to be specified which are suitable for executing the method or for assisting a driver in an energy-efficient operation of a motor vehicle.

This object is solved by the features of the independent claims. Advantageous implementations and further embodiments of the invention will be apparent from the dependent claims.

In accordance with a first aspect of the invention, a method of improving the energy efficiency of a motor vehicle is disclosed. The method comprises the following steps:
detecting a driving situation;
determining an efficient load range for a power train of the motor vehicle depending on the detected driving situation;
detecting a current load of the power train; and
indicating the determined efficient load range and the detected current load in a combined display, so that a driver may selectively move the power train of the motor vehicle into the efficient load range.

By following the above steps, a driver may immediately identify in any situation the action he may take to improve the energy efficiency of his motor vehicle by adjusting his driving style. In contrast to known systems, an immediate, direct and situation-dependent recommendation is displayed, which is not only based on average values, but also guides the driver to an efficient driving style in any given driving situation.

In at least one embodiment, the step of detecting a driving situation includes detecting at least one of the following driving situations: initiating a turning process; completing a turning process; entering a roundabout; exiting a roundabout; approaching an intersection; exiting an intersection; increasing a speed limit; decreasing a speed limit; entering a highway; exiting a highway; initiating an overtaking maneuver; completing an overtaking maneuver; entering a curve; exiting a curve; approaching a vehicle ahead; and approaching a hazardous location. By detecting one of the above-mentioned driving situations typical of road traffic with situation-specific requirements, the most efficient load range for a power train of a motor vehicle may be determined for each of the mentioned driving situations.

According to at least one embodiment, at least one of the following parameters is detected in the step of detecting the driving situation: look-ahead data, in particular a target speed to be expected; a current speed and/or speed change of the motor vehicle and/or a motor vehicle ahead; a state of a direction indicator of the motor vehicle and/or a motor vehicle ahead; a lane on which the motor vehicle and/or a motor vehicle ahead is located; digital traffic network information relating to one or more route sections in the area of a detected position of the motor vehicle; and route information of a navigation system, such as in particular a current speed limit, a speed limit ahead, turn possibilities ahead, roundabouts, etc. By detecting and evaluating the above data, an on-board computer or similar device of a motor vehicle may independently detect which driving situation a motor vehicle is most likely to be in. For example, based on the vehicle's positioning in a turn lane and the setting of a corresponding direction indicator, it may be concluded that the driver intends to turn into a side street. Further indications to a route section to be driven in the future may be provided by an activated navigation system.

According to at least one embodiment, the detected driving situation is associated with one of the following driving maneuvers: accelerating the motor vehicle; decelerating the motor vehicle; and moving the motor vehicle at a constant speed. By assigning a specific driving situation from a plurality of possible driving situations to only one of three driving maneuvers relevant to the power train, the above-mentioned method steps may be implemented particularly easily. For example, it is not necessary to provide a single profile for determining an efficient load range for each of the above-mentioned driving situations. Instead, based on the underlying data of the situation, such as a desired acceleration or deceleration, an efficient load range for a corresponding driving maneuver may be inferred indirectly.

In at least one embodiment the efficient load range is determined depending on at least one of the following parameters: a driving maneuver associated with the detected driving situation; a target speed for a current driving situation and/or driving situation ahead; an actual speed of the motor vehicle; an inclination of the current route section and/or route section ahead and/or of the motor vehicle; a type of the power train; a magnitude of an energy to be recovered by the power train; a magnitude of an energy saving possible by the power train; a maximum power of the power train; and an optimal operating range of the power train. By taking into account one or more of the above-mentioned variables, the efficient load range may be determined, for example, as a function of a current state of the motor vehicle and/or a specific type of drive. For example, in the case of electric vehicles, a relatively large proportion of the kinetic energy may be recovered via the power train by decelerating the vehicle as uniformly as possible. In contrast, for other types of propulsion, such as internal combustion engines, switching off the internal combustion engine at an appropriate time may lead to a gain in efficiency.

In at least one embodiment, a target speed for a current driving situation and/or driving situation ahead is determined as a function of at least one of the following information: a speed limit for a current and/or expected route section; a distance until reaching the expected route section; a distance until reaching a hazardous location; a distance until reaching an apex of a curve; a distance and/or a speed of a vehicle ahead; and a speed learned from fleet data, expected and/or calculated from an expected lateral acceleration in a curve apex, in a roundabout and/or during a turning process. For the determination of an energy-efficient driving style, the focus is in particular on the determination of a target speed that makes sense for a current driving situation or one expected in the near future. In particular, avoiding a driving style that is too fast for a current situation may improve the energy efficiency of a motor vehicle.

In at least one embodiment, in the step of indicating the determined efficient load range and the detected current load, a note for action for reaching the optimal load range is additionally displayed if the detected current load is outside the efficient load range. Additionally or alternatively, a range increase achieved compared to an operation of the motor vehicle with a predetermined reference consumption and/or one calculated to match the driving situation is indicated if the detected current load is within the efficient load range. By indicating such additional notes, a driver of a motor vehicle may be instructed and motivated in a particularly simple manner to operate his motor vehicle in the specific, efficient load range. For example, he may be given a note to reduce acceleration and be positively motivated when following the note by displaying an increase in range thus achieved.

In accordance with a second aspect of the invention, there is disclosed a motor vehicle comprising a power train for driving the motor vehicle, an on-board computer and at least one display device. In this case, the power train comprises a sensor system for determining a current load of the power train, the on-board computer is configured to determine an efficient load range for the power train as a function of a detected driving situation, and the display device is configured to display to a driver of the motor vehicle the efficient load range determined by the on-board computer in combination with a current load of the power train, so that the driver may selectively move the power train of the motor vehicle into the efficient load range. Such a vehicle enables the method according to the first aspect to be implemented, thereby improving the energy efficiency of the motor vehicle.

According to at least one embodiment, the motor vehicle further comprises a map model comprising digital traffic network information and a position finding unit for determining a position of the vehicle on at least one route section of the digital traffic network information. In this case, the digital traffic network information comprises at least one indication regarding a target or maximum speed for the at least one route section according to the determined position, and the on-board computer is configured to determine the efficient load range for the power train as a function of the at least one indication regarding the target and/or maximum speed for the at least one route section. By making such traffic network information available, the on-board computer of the motor vehicle, if necessary, taking into account further of the above-mentioned parameters, may determine a suitable target speed for each route section and thus an efficient load range for operating the motor vehicle.

According to at least one embodiment, the on-board computer is set up to retrieve at least one reference value relating to an efficient driving style for the present driving situation from a reference value module, to determine a corresponding comparison value for a driving style of the driver of the motor vehicle and to compare it with the reference value, and the at least one display device is further configured to display a result of the comparison. For example, average values for the energy-efficient driving style of other drivers may be retrieved by the reference value module. In this way, the driver of the motor vehicle may be encouraged in a playful manner to exceed the reference values provided by his driving style and thus to improve his own driving style even further.

According to at least a third aspect of the invention, there is disclosed a computer-readable medium comprising executable program code, wherein upon execution of the program code on at least one processor of a computer system, a method according to the first aspect is executed.

Further features of the invention will be apparent from the claims, the figures and the following description of the figures. All the features and combinations of features mentioned above in the description, as well as the features and combinations of features mentioned below in the figure description and/or shown alone in the figures, may be used not only in the combination indicated in each case, but also in other combinations or on their own.

Hereinafter, with reference to the accompanying drawings, a preferred embodiment of the invention will be described. Further details, preferred embodiments and further implementations of the invention result therefrom.

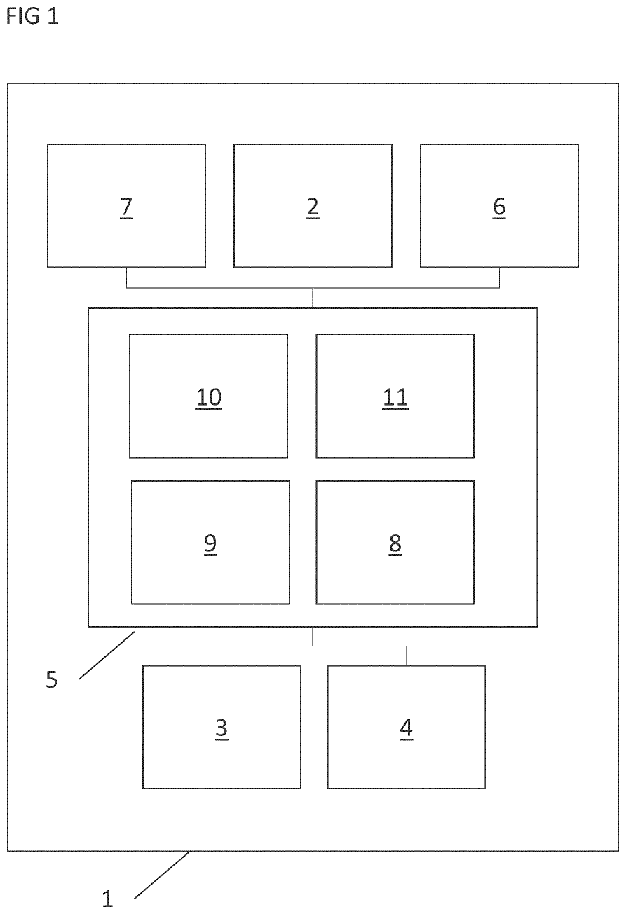

FIG. 1 schematically shows the components of a motor vehicle.

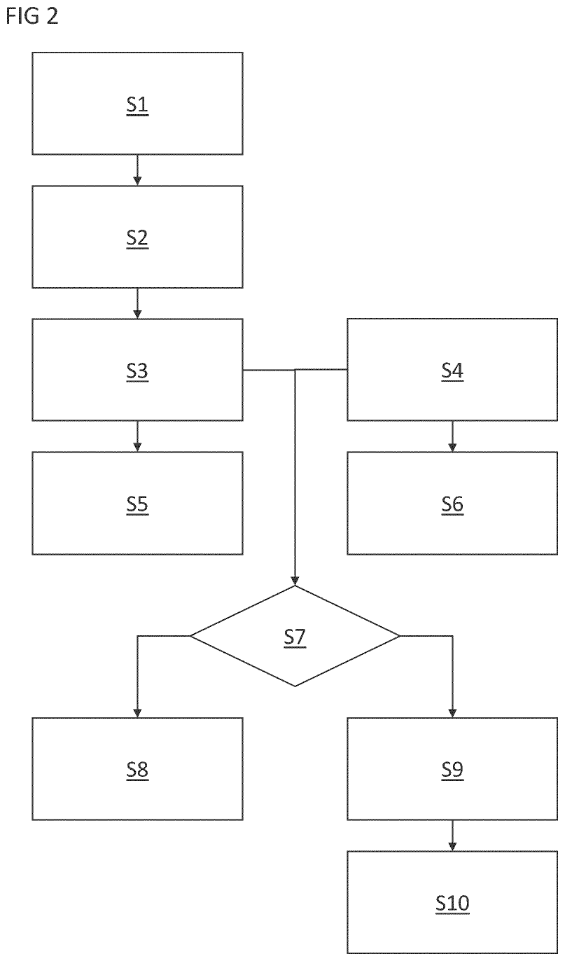

FIG. 2 schematically shows a method for the energy-efficient operation of a motor vehicle.

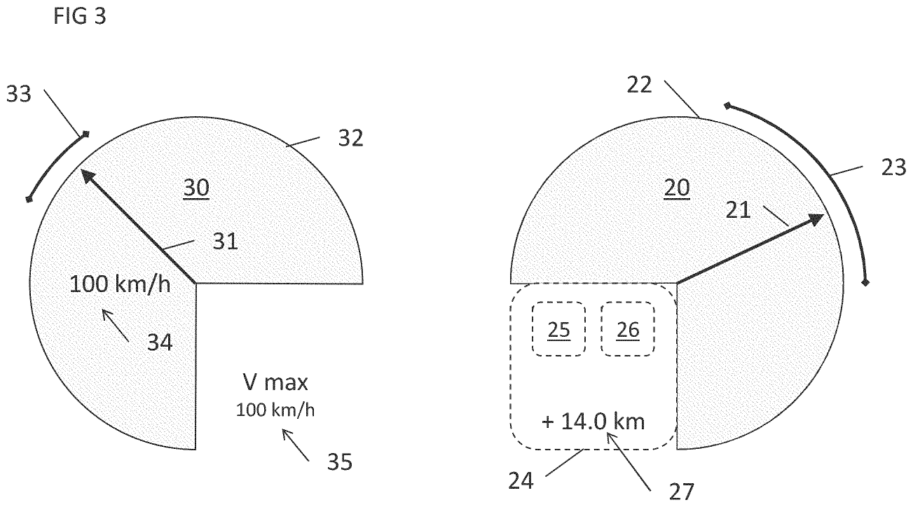

FIG. 3 shows a possible embodiment of a display device of a motor vehicle.

FIG. 1 schematically shows the different components of a motor vehicle 1. The motor vehicle 1 comprises a power train 2, control elements 3 and at least one display device 4. Power train 2, control elements 3 and display device 4 are interconnected via an on-board computer 5.

The power train 2 is, for example, an electric motor, an associated power control, and a battery system of an electric vehicle. Alternatively, the power train 2 is an internal combustion engine, with associated control elements and a fuel delivery system. Of course, other types of drive and their combination are also possible, in particular hybrid vehicles comprising an electric drive and a drive based on an internal combustion engine.

The power train 2 comprises a plurality of control elements and sensors which may be controlled and/or read out by the on-board computer 5. Characteristic data for the power train, for example an optimum operating point or operating range for the engine of the power train 2, may also be stored in the power train 2 itself or in a corresponding memory of the onboard computer 5.

A driver of the motor vehicle 1 controls the power train 2 via the control elements 3. In particular, the control elements may comprise an acceleration pedal for accelerating the motor vehicle 1 (in particular an accelerator pedal in the case of an internal combustion engine) and a brake pedal for braking the vehicle 1. Particularly in vehicles with electric drive, the functions of an accelerator and brake pedal may also be partially combined. For example, when the accelerator pedal is released and/or the brake pedal is depressed slightly, part of the kinetic energy may be recovered as electrical energy by means of so-called recuperation, for example by operating the electric motor as a generator. Only when the brake pedal is depressed more strongly, for example in a full braking maneuver, are conventional, mechanical braking systems additionally or alternatively activated, which essentially convert the kinetic energy of the vehicle into thermal energy.

Via the display device 4, essential operating parameters of the vehicle 1 are displayed to the driver. This typically includes an indication of a current speed and load of the power train 2. Additionally, in the described embodiment, an efficient load range is displayed via the display device 4.

In the illustrated embodiment, the motor vehicle 1 further comprises a radio module 6 and further sensors 7 that provide further functions to improve the operation of the motor vehicle 1. For example, the radio module 6 may comprise a so-called GPS receiver for determining a current vehicle position. Additionally or alternatively, other data may be exchanged with a data network via the radio module 6. For example, the on-board computer 5 may retrieve reference values for the most energy-efficient operation of the motor vehicle or current traffic data via the radio module 6. For example, the further sensors 7 may comprise a distance sensor for determining a distance of the motor vehicle 1 from a vehicle or obstacle ahead. In addition, information may be evaluated to determine a current driving position, in particular a speed and inclination of the motor vehicle.

In the embodiment, all of the above-mentioned components are monitored by the on-board computer 5 and their states are evaluated as described in detail below. For this purpose, different modules with program code are executed on the on-board computer 5. A digital map module 8 determines current traffic network information for a surrounding area of the motor vehicle 1. This includes, in particular, currently possible connections, information on speed limits for a current route section and other information on a topology of the traffic network, such as curve radii, directional lanes and so on. The map module 8 is preferably configured as a navigation module that not only provides the traffic network information, but also uses it to suggest routes for a current trip. If the driver follows the suggested route, it is highly probable that route sections to be travelled in the near future may be predicted accurately.

Based on this and other data, a look-ahead module 9 recognizes different driving situations that are to be expected or have already been initiated. For example, when approaching the end of a current route section, the look-ahead module 9 may detect that the subsequent road section includes a turnoff, a hazardous location, or a roundabout.

This information is evaluated by an efficiency module 10, also referred to as an efficiency trainer. For example, the efficiency module 10 detects that deceleration of the motor vehicle 1 is required when the motor vehicle 1 enters a roundabout. Based on the driving maneuver detected by the efficiency module 10, a corresponding efficient load range for the power train 2 is determined and displayed to the driver via at least one display device 4, as described below.

If the driver then brings the power train 2 into a corresponding efficient load range via the control elements 3, this is confirmed via the display device 4. For example, an absolute and/or relative increase in range of the motor vehicle compared to a comparative value of an average driver obtained via a reference value module 11 may be displayed in the display device 4.

FIG. 2 schematically shows the sequence of a process for improving the energy efficiency of a motor vehicle, for example the motor vehicle 1 shown in FIG. 1.

In a first step S1, a driving situation for the motor vehicle 1 is detected. A driving situation may be determined on the basis of different sensor data. The basis for this is, for example, so-called look-ahead data from the on-board computer 5, which in particular may determine a target speed expected in the near future. For example, based on digital traffic network information, it may be determined that the vehicle 1 is approaching a hazardous location, intersection, or other situation that requires a reduction in current speed. Conversely, it may be determined that after passing through such a location, the following section should be traveled at a higher target speed.

Based on the detected driving situation, a corresponding driving maneuver is determined in the subsequent step S2. This step serves in particular to reduce the plurality of possible driving situations to driving maneuvers relevant for the power train 2 and its energy efficiency. In the described embodiment, all of the detected driving situations are assigned to one of three possible driving maneuvers, namely acceleration of the vehicle 1, constant driving of the vehicle 1, that is, moving the vehicle at a constant speed, and deceleration of the motor vehicle 1. Each of these driving maneuvers may be determined by additional parameters. In particular during acceleration and deceleration, the amount by which a speed and/or a load of the power train 2 is to be reduced within which time period or travel distance may be specified in each case. For this purpose, in particular a current actual speed of the vehicle 1, a target speed taken from the look-ahead data or the specific driving situation and a distance up to a point at which the target speed is to be reached at the latest are taken into account.

Based on the driving maneuver determined in step S2, an efficient load range for implementing the determined driving maneuver is calculated in step S3. For example, in step S3 it may be calculated whether gliding, i.e., allowing the vehicle 1 to coast without supplying power to a drive unit, is sufficient to achieve a planned deceleration, or whether further measures, such as engine braking or active braking, are required to achieve the desired target speed. Conversely, during constant driving and acceleration, it is possible to determine how much energy must be supplied to the drive unit in order to maintain a target speed or to reach a new target speed.

In the embodiment, the efficient load range during acceleration is between 0% and a predetermined positive value for the respective type of drive system, for example 70%. For deceleration, the efficient load range is between 0% and a negative value specified for the respective type of drive system. If the current actual speed is above a maximum permissible speed, coasting is always recommended, that is, an output power of 0%. In constant driving, the efficient load range is, for example, between 0% and a positive value determined, for example, as a function of a slope and an optimum operating point or range of the power train 2. If applicable, a negative value for the recommended load may also be useful for constant driving, for example when a motor vehicle driving ahead is detected. The recommended load ranges should preferably not be selected too narrow in order to facilitate their observance by the driver and not to distract him from other tasks.

In addition, in a step S4, the actual load of the power train 2 is determined. In the case of conventional drive types, in particular internal combustion engines, no energy may usually be recovered via the engine, so that the minimum energy or fuel consumption is zero. However, an internal combustion engine may also produce negative torque by means of thrust cutoff, also known as “engine braking,” and thus provide a negative load for the power train. In contrast, new types of drive, in particular fully electric drives with the possibility of recuperation, i.e., the conversion of kinetic energy by the motor back into electrical energy, may recover at least part of the energy already expended. Accordingly, negative load ranges or loads may also be determined in steps S3 and S4.

In steps S5 and S6 executed in parallel, the efficient load range determined in step S3 is displayed together with the current load determined in step S4. For example, in the area of a so-called power display, it is possible to visualize in a simple manner whether the load actually delivered falls within the efficient load range by appropriately depositing a part of the display with the desirable, efficient load range and simultaneously displaying a current specific load.

In the case of electrified vehicles, the display of the efficient load range is interesting, among other things, because from a certain deceleration requirement on the part of the driver, recuperation alone (recovery of energy via generator operation) is no longer sufficient, but a mechanical friction brake must also intervene. By determining these different deceleration modes, the maximum efficient deceleration may be well derived and communicated to the driver.

Additionally, the method may comprise the following optional steps.

In a step S7, it is first determined whether the load currently selected by the driver falls within the efficient load range determined in step S3. If this is not the case, a corresponding note for action is displayed in a step S8, which indicates to the driver which measures he may take to enter the efficient load range.

If the driver follows the appropriate notes for action and, upon rechecking in step S7, it is determined that the active load is now in the efficient load range, a range increase for the motor vehicle 1 resulting from this behavior is determined in a step S9. For this purpose, an optimum load point may be determined in addition to the efficient load range. The optimum operating point is the point at which the range gain increases most rapidly, i.e., the most efficient driving style for the driving situation at hand. The greater the distance to this ideal, situation-dependent point, the smaller the build-up of additional range. Outside of the load recommendation, the buildup of the bonus range is then zero. For example, the on-board computer 5 may calculate by how many additional kilometers the vehicle 1 may be moved compared to a reference consumption for the current trip. As a reference for the calculation of a corresponding bonus range, the consumption of an average driver or one's own previous trip may be used, for which the consumption and thus the achieved range are known.

To further motivate the driver, the result of this determination is displayed in a subsequent step S10. In addition or alternatively, it is also possible to display the actual range increase achieved relative to a maximum possible range increase in percentage form. To determine the maximum possible increase in range, an optimum load point or at least a load point that is always in the specific efficient load range may be used as a basis. In addition or alternatively, it is also possible to compare the range increase actually achieved with an efficiency achieved by other drivers of a motor vehicle of the same type. Ideally, the display of the success that has occurred should be close to the displayed efficient load range or the current load. In the embodiment described, the total bonus range achieved, absolute or relative, is displayed for each trip made, allowing the driver to observe an improvement or deterioration in their driving.

FIG. 3 shows an example of a suitable display device 4 for displaying the information determined in the method according to FIG. 2. In the embodiment, the display device 4 is a so-called combination display in the direct field of view of the driver. Typically, the combination display shows the current power in a power display range 20 and the current speed in a speed display range 30. Alternatively, it may also be a so-called head-up display (HUD), i.e., a display of corresponding data directly in the driver's field of vision, for example by projection onto the inside of a windscreen, or a multifunction display in the area of a center console. It is advantageous if the corresponding variable to be influenced by the driver, i.e., the engine power and/or the engine torque corresponding to the load and/or the actual speed is displayed in each case together with the efficient range suggested by the efficiency module 10 of the on-board computer 5, as described below.

The power display range 20 and/or load range comprises a power display configured as a first trailing pointer 21 and modeled corresponding to an analogue display instrument such as a tachometer, a first outer band 22 for displaying an efficient load range 23 highlighted in color, and a freely usable and/or programmable display area 24 on which various symbols relating to an efficient driving style may be displayed. In the embodiment, a note of action 25 may be displayed in the upper left portion of the display area 24, a control of success 26 may be displayed in the upper right portion of the display area 24, and a bonus range 27 determined by an efficiency module 10 may be displayed in the lower portion of the display area 24. In case of an efficient driving style, the first trailing pointer 21 is always within the efficient load range 23 highlighted on the first outer band 22.

In the embodiment, the speed display area 30 comprises a speed display configured as a second trailing pointer 31 and modeled corresponding to an analogue speedometer, an optional second outer band 32 for displaying a target speed range 33, a central numerical display 34 on which the current actual speed is output as a numerical value, and a display 35 located in the lower area for displaying a maximum speed permitted in a current section of the route.

If the driver is outside the recommended efficient load range 23, a note of action 25 is displayed to the driver, while the remaining elements, that is, the success control 26 and the bonus range 27 are grayed out. For example, a first note of action 25 may illustrate that the driver should lightly remove his or her foot from the accelerator pedal. A second note of action, however, may make it clear that the driver should take his foot completely off the accelerator pedal. Corresponding notes of action 25 are also provided for a light or strong operation of the accelerator pedal, respectively.

If the driver follows the note for action and thus reaches the efficient load range 23, the note for action 25 disappears and the success control 26 lights up instead. Additionally, the calculated bonus range 27 is displayed, which is always built up when the driver is within the recommended load range 23.

All in all, the display elements of the display area 24 thus enable an intuitively understandable display that encourages the driver to drive efficiently and, when corresponding notes for action 25 are followed, immediately motivates the driver with corresponding incentives in the form of success control 26 and achieved bonus range 27. In particular, by means of an animated display of the success control 26, such as, for example, a faster or slower filling of a corresponding graphical display, it may also be intuitively communicated to the driver which measures lead to a particularly high increase in efficiency and thus an increase in range.

Different driving situations and their effect on the display elements described above are described below.

### Scenario 1: Driving on a Hilly Country Road

In a first scenario, the motor vehicle is on a hilly country road. The prescribed maximum speed for the route section is 100 km/h, which is indicated by the second outer band 32 of the speedometer. The actual speed of the motor vehicle 1 is also 100 km/h. To maintain this speed, the on-board computer 5 calculates a required load for the power train 2 depending on a maximum engine power, an engine type, and an inclination of the current route section. Due to the relatively rapidly changing inclination of the country road, the efficient load range 23 comprises a relatively large scope of, for example, 0 to 70% of the available engine power. In the described scenario, the driver applies the accelerator pedal to the extent that an engine power of 10% results, which is within the determined efficient load range 23. Accordingly, the success control 26 and the calculated bonus range 27 are active.

If the inclination of the current route section increases and the speed of the motor vehicle 1 decreases to, for example, 80 km/h while the engine power remains the same, the display remains substantially unchanged because an actual speed of 80 km/h is just about still within the suggested target speed range 33 of between 80 and 100 km/h. The same applies if the driver presses the accelerator pedal slightly further to increase speed, for example to increase the output power from 10 to 20% of the available power. This power range and a resulting actual speed of 91 km/h are also within the range of values suggested by the efficiency module 10, so that success control 26 and bonus range 27 each remain active.

### Scenario 2: Roundabout

As the route section continues, the motor vehicle 1 approaches a roundabout. In this situation, the speed limit of 100 km/h still applies. In addition, the look-ahead module 9 determines that an entry to the roundabout is expected in 400 m. 200 m before reaching the roundabout, the target speed determined by the on-board computer is reduced to 60 km/h. Accordingly, a load recommendation of 0%, that is, allowing the vehicle to coast, is recommended over the first outer band 22 of the power display area 20. Correspondingly, the note for action 25b for completely removing the foot from the accelerator pedal is displayed. As long as the driver keeps his foot on the accelerator pedal, this note for action 25b is displayed. The success control 26 and the bonus range 27 are grayed out to indicate to the driver that he is not efficiently controlling the motor vehicle 1.

If the driver follows the note and takes his foot completely off the accelerator, the actual speed drops to 40 km/h and the load display to 0%. In this state, the success control 26 and the bonus range 27 are activated again. For example, by means of a so-called gliding operation, the driver finally reaches the roundabout at a suitable entry speed. For example, the entry speed is calculated using the radius of the roundabout and a usual lateral acceleration. If the driver consistently follows the deceleration note triggered at the optimal time, the vehicle will arrive at the roundabout at exactly the desired entry speed. Unnecessary, energy-inefficient mechanical braking of the vehicle 1 may thus be dispensed with.

Once the driver has passed through the roundabout at a relatively low speed and enters a new route section, the speed limit of 100 km/h applies again. Accordingly, a range of 80 to 100 km/h is again indicated on the outer band 32 as the target speed range 33. For the required increase in speed, an efficient load range 23 between 0 and 70% of the output power is displayed on the outer band 22 of the power display. In the scenario described, the driver then initially applies almost full throttle, in the embodiment 80% of the available power. Although such acceleration leads in the direction of the target speed, it represents inefficient power output by the power train 2, so the note for action 25a is displayed in the display area 24 to make this clear to the driver. If the driver then withdraws the accelerator pedal a little so that the power output drops to, for example, 20% of the available power, the success control 26 and the bonus range 27 are displayed again. Even with such a slight acceleration, the motor vehicle 1 eventually reaches the desired target speed of 100 km/h.

### LIST OF REFERENCE NUMBERS

1 Motor vehicle
2 Power train
3 Control elements
4 Display device
5 On-board computer
6 Radio module
7 Additional sensors
8 Digital map
9 Look-ahead module
10 Efficiency module
11 Reference value module
20 Power display range
21 First trailing pointer (of the power display)
22 First outer band (of the power display)
23 Efficient load range
24 Display area
25 Note for action
26 Control of success
27 Bonus range
30 Speed display range
31 Second trailing pointer (of the speed indicator)
32 Second outer band (of the speed indicator)
33 Target speed range
34 Numerical display (of the actual speed)
35 Display (of maximum admissible speed)
S1 to S10 Method steps

1. A method for improving the energy efficiency of a motor vehicle, comprising the steps of:
detecting a driving situation;
determining an efficient load range for a power train of the motor vehicle depending on the detected driving situation;
detecting a current load of the power train; and
indicating the determined efficient load range and the detected current load in a combined display device, so that a driver may selectively move the power train of the motor vehicle into the efficient load range.

2. The method of claim 1, wherein in the step of detecting a driving situation, at least one of the following driving situations is detected:
initiating a turning process; completing a turning process; entering a roundabout; exiting a roundabout; approaching an intersection; exiting an intersection; increasing a speed limit; decreasing a speed limit; entering a highway; exiting a highway; initiating an overtaking maneuver; completing an overtaking maneuver; entering a curve; exiting a curve; approaching a vehicle ahead; and approaching a hazardous location.

3. The method of claim 1, wherein in the step of detecting a driving situation, at least one of the following parameters is detected:
look-ahead data, in particular a target speed to be expected; a current speed and/or speed change of the motor vehicle and/or a motor vehicle ahead; a state of a direction indicator of the motor vehicle and/or a motor vehicle ahead; a lane on which the motor vehicle and/or a motor vehicle ahead is located; digital traffic network information relating to one or more route sections in the area of a detected position of the motor vehicle; and route information of a navigation system.

4. The method of claim 1, wherein the detected driving situation is associated with one of the following driving maneuvers:
accelerating the motor vehicle; decelerating the motor vehicle; and moving the motor vehicle at a constant speed.

5. The method according to claim 1, wherein the efficient load range is determined as a function of at least one of the following parameters:
a driving maneuver associated with the detected driving situation; a target speed for a current driving situation and/or driving situation ahead; an actual speed of the motor vehicle; an inclination of the current route section and/or a route section ahead and/or of the motor vehicle; a type of the power train; a magnitude of an energy to be recovered by the power train; a magnitude of an energy saving possible by the power train; a maximum power of the power train; and an optimal operating range of the power train.

6. The method of claim 5, wherein the target speed for a current driving situation and/or driving situation ahead is determined as a function of at least one of the following information:
a speed limit for a current and/or expected route section; a distance until reaching the expected route section; a distance until reaching a hazardous location; a distance until reaching an apex of a curve; a distance and/or a speed of a motor vehicle ahead; and a speed learned from fleet data, expected and/or calculated from an expected lateral acceleration in a curve apex, in a roundabout and/or during a turning process.

7. The method of claim 1, further comprising:
determining an increase in range compared with an operation of the motor vehicle with a predetermined reference consumption, in particular a reference consumption calculated and/or determined as a function of the driving situations.

8. The method according to claim 1, wherein in the step of indicating the determined efficient load range and the detected current load, a note for action for reaching the efficient load range is additionally displayed if the detected current load is outside the efficient load range, and/or a range increase achieved compared to an operation of the motor vehicle with a predetermined reference consumption is displayed if the detected current load is within the efficient load range.

9. A motor vehicle comprising:
a power train for driving the motor vehicle, wherein the power train comprises a sensor system for determining a current load of the power train;
an on-board computer configured to determine an efficient load range for the power train in dependence on a detected driving situation; and
at least one display device which is configured to display to a driver of the motor vehicle the efficient load range determined by the on-board computer in combination with a current load of the power train, so that the driver may selectively move the power train of the motor vehicle into the efficient load range.

10. The motor vehicle of claim 9, wherein the on-board computer is further configured to determine a preferred position for at least one control element, in particular an accelerator pedal and/or a brake pedal, which puts the power train of the motor vehicle into the efficient load range, and the at least one display device is further configured to display a note regarding the preferred position to the driver of the motor vehicle.

11. The motor vehicle of claim 9, wherein the on-board computer is further configured to determine a positive effect achieved by operating the motor vehicle in the efficient load range, in particular an achieved range increase or an achieved consumption value, and the at least one display device is further configured to display a reward relating to the achieved positive effect to the driver the motor vehicle.

12. The motor vehicle of claim 9, further comprising a map module with digital traffic network information and a position finding unit for deter-mining a position of the motor vehicle on at least one route section of the digital traffic network information, wherein the digital traffic network information comprises at least one indication relating to a target or maximum speed for the at least one route section according to a determined position of the motor vehicle, and the on-board computer is further arranged to determine the efficient load range for the power train in dependence on the at least one indication relating to the target and/or maximum speed for the at least one route section.

13. A motor vehicle of claim 9, wherein the on-board computer is further configured to retrieve at least one reference value relating to an efficient driving style from a reference value module, to determine a corresponding comparison value for a driving style of the driver of the motor vehicle and to compare it with the reference value, and the at least one display device is further configured to display a result of the comparison.

14. A non-transitory, computer-readable medium with executable program code, wherein when the program code is executed on at least one processor of a computer system, in particular on an on-board computer of a motor vehicle, a method according to claim 1 is executed.
